(19) United States
(12) Patent Application Publication
(10) Pub. No.: US 2023/0334716 A1
(43) Pub. Date: Oct. 19, 2023

(54) APPARATUS AND METHOD FOR PROVIDING 3-DIMENSIONAL SPATIAL DATA BASED ON SPATIAL RANDOM ACCESS

(71) Applicant: ELECTRONICS AND TELECOMMUNICATIONS RESEARCH INSTITUTE, Daejeon (KR)

(72) Inventors: Jin-Young LEE, Seoul (KR); Kyu-Heon KIM, Seoul (KR); Jun-Sik KIM, Yongin-si (KR); Kwu-Jung NAM, Suwon-si (KR)

(73) Assignee: ELECTRONICS AND TELECOMMUNICATIONS RESEARCH INSTITUTE, Daejeon (KR)

(21) Appl. No.: 18/302,473

(22) Filed: Apr. 18, 2023

(30) Foreign Application Priority Data
Apr. 19, 2022 (KR) 10-2022-0048340
Apr. 5, 2023 (KR) 10-2023-0044725

(51) Int. Cl. G06T 9/00; H04L 65/70

(52) U.S. Cl. CPC G06T 9/001; H04L 65/70

(57) ABSTRACT

Disclosed herein are an apparatus and method for providing 3D spatial data based on spatial random access. The method may include generating multiple groups of frames by grouping 3D spatial data based on an adjacent location in a space, compressing the 3D spatial data for each of the groups of frames, and encapsulating a compressed 3D spatial data bitstream for each of the groups of frames.

### CROSS REFERENCE TO RELATED APPLICATIONS

This application claims the benefit of Korean Patent Applications No. 10-2022-0048340, filed Apr. 19, 2022, and No. 10-2023-0044725, filed Apr. 5, 2023, which are hereby incorporated by reference in their entireties into this application.

### BACKGROUND OF THE INVENTION

### 1. Technical Field

The disclosed embodiment relates to a method for compressing and transmitting three-dimensional (3D) spatial data so as to enable spatial random access thereto.

### 2. Description of the Related Art

3D spatial data is acquired through a Light Detection And Ranging (LiDAR) sensor or a fixed RGB camera set and receives attention as a next-generation 3D content representation method in various fields including autonomous driving, augmented reality, virtual reality, and the like.

Generally, 2D image data is provided so as to be consumed according to a time domain. That is, a user may be provided with data of a specific time point desired by the user, among multiple pieces of 2D image data, through temporal random access.

3D spatial data may also be consumed based on a time domain in the same manner as existing 2D image data is consumed. However, 3D spatial data may be alternatively consumed based on a spatial domain in a service such as autonomous driving or the like.

In order to provide only the data corresponding to a specific location, rather than multiple pieces of 3D spatial data or the entirety of a single piece of massive 3D data, it is necessary to support spatial random access in a compression and transmission process.

However, technologies for compressing and transmitting 3D spatial data do not yet support spatial random access.

### SUMMARY OF THE INVENTION

An object of the disclosed embodiment is to propose compression and transmission technology that supports spatial random access such that 3D spatial data is consumed in a spatial domain.

A method for providing three-dimensional (3D) spatial data based on spatial random access according to an embodiment may include generating multiple groups of frames by grouping 3D spatial data based on an adjacent location in a space, compressing the 3D spatial data for each of the groups of frames, and encapsulating a compressed 3D spatial data bitstream for each of the groups of frames.

Here, each of the groups of frames may include an I frame that is a reference frame, a P frame that refers to one of adjacent I frames and P frames when being decoded, and a B frame that refers to at least two of adjacent I frames and P frames when being decoded.

Here, encapsulating the compressed 3D spatial data bitstream may comprise generating a 3D spatial data file in an ISO base media file format (ISOBMFF), which supports spatial random access, from the compressed 3D spatial data bitstream.

Here, encapsulating the compressed 3D spatial data bitstream may comprise generating a frame spatial information box in a SampleEntry box of an ISOBMFF standard and storing location information of 3D spatial data frames for each of the groups of frames therein.

Here, the location information of the 3D spatial data frame may be absolute coordinates of the 3D spatial data frame or relative coordinates of a group of 3D spatial data frames.

Here, the frame spatial information box may include the number of 3D spatial data frames having location information (num_SpatialInfo), frame latitude information, and frame longitude information.

Here, the frame spatial information box may further include frame altitude information, frame speed information, and frame direction information, and each of the frame altitude information, the frame speed information, and the frame direction information may be omitted depending on skip flag information indicating whether a parameter therefor is omitted.

The method for providing 3D spatial data based on spatial random access according to an embodiment may further include transmitting the 3D spatial data encapsulated for each of the groups of frames to a user through a media transmission protocol, and spatial random access to a 3D spatial data frame may be supported using location information included in a frame spatial information box.

An apparatus for providing three-dimensional (3D) spatial data based on spatial random access according to an embodiment includes memory in which at least one program is recorded and a processor for executing the program. The program may generate multiple groups of frames by grouping 3D spatial data based on an adjacent location in a space, compress the 3D spatial data for each of the groups of frames, and encapsulate a compressed 3D spatial data bitstream for each of the groups of frames.

Here, each of the groups of frames may include an I frame that is a reference frame, a P frame that refers to one of adjacent I frames and P frames when being decoded, and a B frame that refers to at least two of adjacent I frames and P frames when being decoded.

Here, when encapsulating the compressed 3D spatial data bitstream, the program may generate a 3D spatial data file in an ISO base media file format (ISOBMFF), which supports spatial random access, from the compressed 3D spatial data bitstream.

Here, when encapsulating the compressed 3D spatial data bitstream, the program may generate a frame spatial information box in a SampleEntry box of an ISOBMFF standard and store location information of 3D spatial data frames for each of the groups of frames therein.

Here, the location information of the 3D spatial data frame may be absolute coordinates of the 3D spatial data frame or relative coordinates of a group of 3D spatial data frames.

Here, the frame spatial information box may include the number of 3D spatial data frames having location information (num_SpatialInfo), frame latitude information, and frame longitude information.

Here, the frame spatial information box may further include frame altitude information, frame speed information, and frame direction information, and each of the frame altitude information, the frame speed information, and the frame direction information may be omitted depending on skip flag information indicating whether a parameter therefor is omitted.

Here, the program may transmit the 3D spatial data encapsulated for each of the groups of frames to a user through a media transmission protocol, and the program may support spatial random access to a 3D spatial data frame using location information included in a frame spatial information box.

A method for providing three-dimensional (3D) spatial data based on spatial random access according to an embodiment includes generating multiple groups of frames by grouping 3D spatial data based on an adjacent location in a space, compressing the 3D spatial data for each of the groups of frames, encapsulating a compressed 3D spatial data bitstream for each of the groups of frames, and transmitting the 3D spatial data encapsulated for each of the groups of frames to a user through a media transmission protocol. Here, encapsulating the compressed 3D spatial data bitstream may comprise generating a frame spatial information box in a SampleEntry box of an ISO base media file format (ISOBMFF) standard and storing location information of 3D spatial data frames for each of the groups of frames therein, and transmitting the 3D spatial data may comprise supporting spatial random access to the 3D spatial data frame using the location information included in the frame spatial information box.

Here, each of the groups of frames may include an I frame that is a reference frame, a P frame that refers to one of adjacent I frames and P frames when being decoded, and a B frame that refers to at least two of adjacent I frames and P frames when being decoded.

Here, the frame spatial information box may include the number of 3D spatial data frames having location information (num_SpatialInfo), frame latitude information, and frame longitude information.

Here, the frame spatial information box may further include frame altitude information, frame speed information, and frame direction information, and each of the frame altitude information, the frame speed information, and the frame direction information may be omitted depending on skip flag information indicating whether a parameter therefor is omitted.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is an exemplary view for explaining a method of consuming 2D image data;

FIG. 2 is an exemplary view for explaining a method of consuming 3D spatial data;

FIG. 3 is a flowchart for explaining a method for providing 3D spatial data based on spatial random access according to an embodiment;

FIG. 4 is an exemplary view for explaining a step of generating groups of frames according to an embodiment;

FIG. 5 is an exemplary view for explaining a frame spatial information box according to an embodiment; and

FIG. 6 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

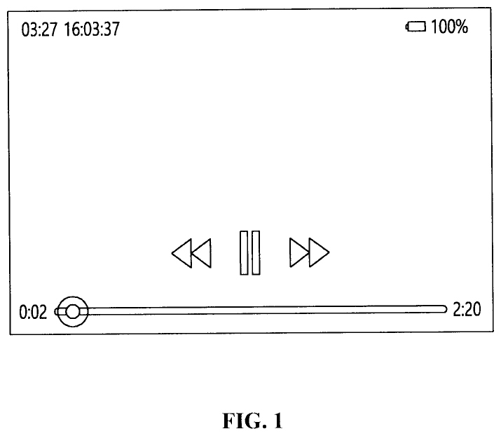

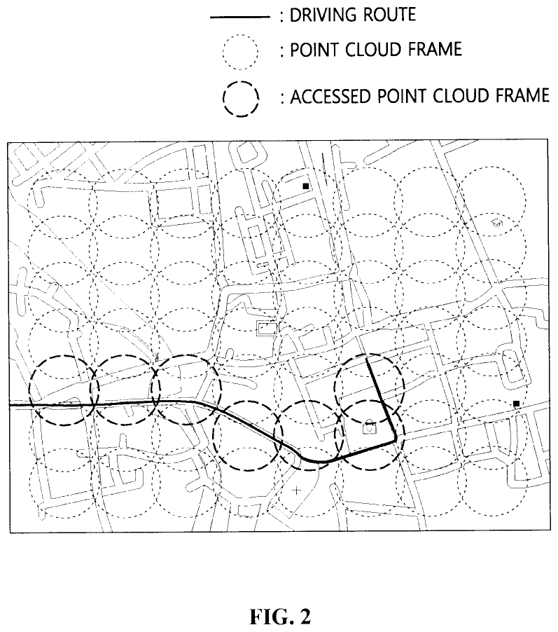

FIG. 1 is an exemplary view for explaining a method of consuming 2D image data, and FIG. 2 is an exemplary view for explaining a method of consuming 3D spatial data.

Generally, 2D image data may be consumed along a time domain. For example, a user may reproduce data of a specific time point desired by the user by moving a time control bar to the left or right in a display screen such as that illustrated in FIG. 1.

That is, a system for providing 2D image data may provide a user with 2D image data of a time point desired by the user, among multiple pieces of 2D image data, through a temporal random access method.

3D spatial data may also be consumed based on a time domain in the same manner as existing 2D image data is consumed.

Alternatively, 3D spatial data may be consumed based on a spatial domain in a service such as autonomous driving or the like. For example, among point cloud frames corresponding to multiple pieces of 3D spatial data, only point cloud frames located along a driving route may be consumed through a spatial random access method, as illustrated in FIG. 2.

Here, in order to enable a user to randomly access and acquire only 3D spatial data of a specific location, rather than multiple pieces of 3D spatial data or the entirety of a single piece of massive 3D data, it is necessary to support compression and transmission of 3D spatial data so as to enable spatial random access in the system.

Accordingly, an embodiment provides an apparatus and method capable of compressing and transmitting 3D spatial data such that spatial random access is possible.

3D spatial data may be consumed based not only on a time domain but also on a spatial domain. Therefore, a system for compressing and transmitting 3D spatial data is required to provide spatial data of a specific location desired by a user, among multiple pieces of 3D spatial data. In order to provide pieces of 3D spatial data based on a spatial domain, it is necessary to support spatial random access, but existing systems for compressing and transmitting 3D spatial data do not support spatial random access.

Therefore, an embodiment provides an apparatus and method for providing 3D spatial data by compressing and transmitting the same such that 3D spatial data of a specific location, among multiple pieces of 3D spatial data, is capable of being provided according to a spatial domain.

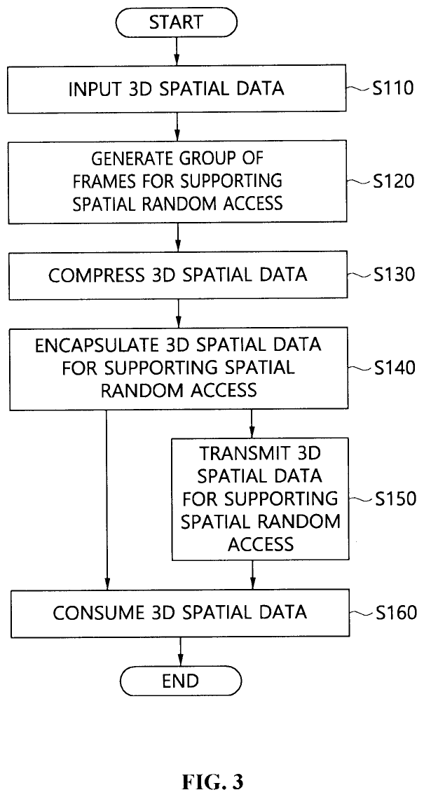

FIG. 3 is a flowchart for explaining a method for providing 3D spatial data based on spatial random access according to an embodiment.

Referring to FIG. 3, the method for providing 3D spatial data based on spatial random access according to an embodiment may include generating multiple groups of frames by grouping 3D spatial data based on an adjacent location in a space at step S120, compressing the 3D spatial data for each of the groups of frames at step S130, and encapsulating a compressed 3D spatial data bitstream for each of the groups of frames at step S140.

The method for providing 3D spatial data based on spatial random access according to an embodiment may further include receiving 3D spatial data at step S110. At step S110, each of still images included in the received 3D spatial data may include 3D spatial data and metadata related thereto.

At the step (S120) of generating multiple groups of frames according to an embodiment, a group of frames may be generated depending on spatial characteristics of the received 3D spatial data.

In existing 2D images, a time shift does not mean image movement unless there is rapid movement of a camera. However, 3D spatial data acquired through a LiDAR sensor or the like has two attributes of a time shift and a space shift depending on the movement of a vehicle in which the sensor is installed.

Accordingly, in order to effectively compress 3D spatial data, it is necessary to generate a group of frames using spatial characteristics. Particularly, it is likely that 3D spatial data is to be consumed based on a spatial domain, so technology for generating groups of frames capable of supporting spatial random access is required.

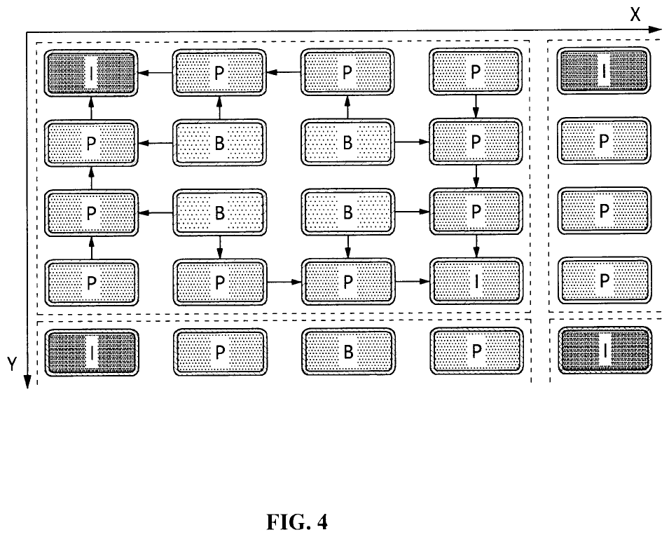

FIG. 4 is an exemplary view for explaining a step of generating groups of frames according to an embodiment.

Referring to FIG. 4, at the step (S120) of generating groups of frames, a group-of-frame generation method in which only pieces of 3D spatial data closest to each other are used for prediction is performed. That is, in the spatial coordinate system formed of an X-axis and a Y-axis, multiple image frames that are closest to each other, which are depicted as being separated by the dotted line, may be generated as each group of frames (GOF).

Here, each group of frames may include an I frame that is a reference frame, a P frame that refers to one of adjacent I frames and P frames when it is decoded, and a B frame that refers to at least two of adjacent I frames and P frames when it is decoded.

That is, as illustrated in FIG. 4, a frame pointed by the arrow connected to each of the frames may be the frame to be referred to when a terminal receiving each of the frames decodes the same. For example, an I frame is a reference frame, and may be referred to by P frames. Also, a B frame may refer to two frames adjacent thereto.

Here, the P and B frames and a prediction structure may be determined depending on the spatial characteristics of the 3D spatial data.

Meanwhile, at the step (S130) of compressing the 3D spatial data according to an embodiment, general 3D spatial data compression technologies may be used.

With regard to a point cloud, among 3D spatial data, the Moving Picture Expert Group (MPEG) of ISO/IEC JTC1, which is an international standard organization, is working on standardization of compression of a point cloud based on structures such as Geometry-based Point Cloud Compression (G-PCC) and Video-based Point Cloud Compression (V-PCC). However, in these structures, 3D spatial data is represented in 2D, the connection between points is represented as a node, and the entire 3D spatial data is regarded as a single target to be compressed or transmitted. Accordingly, data can be accessed only along a time axis, and a function for spatial access is not provided.

Accordingly, in an embodiment, 3D spatial data is compressed for each group of frames in order to provide a spatial access function.

Also, at the step (S140) of encapsulating the compressed 3D spatial data bitstream for each group of frames according to an embodiment, a 3D spatial data file in an ISO base media file format (ISOBMFF), which supports spatial random access, may be generated from the compressed 3D spatial data bitstream.

Here, the 3D spatial data may be encapsulated in various manners. A single piece of high-precision 3D spatial data may be segmented into multiple pieces of 3D spatial data for convenience of provision of a service, and multiple pieces of 3D spatial data may be regarded as a single piece of high-precision 3D spatial data. Accordingly, it is required to support spatial random access both in each 3D spatial data frame and in segments in the frame.

According to an embodiment, at the step (S140) of encapsulating the compressed 3D spatial data bitstream, a frame spatial information box is generated in a SampleEntry box of the ISOBMFF standard, whereby location information of the 3D spatial data frames may be stored for each group of frames.

Here, the location information of the 3D spatial data frame may be the absolute coordinates of the 3D spatial data frame or the relative coordinates of a group of 3D spatial data frames.

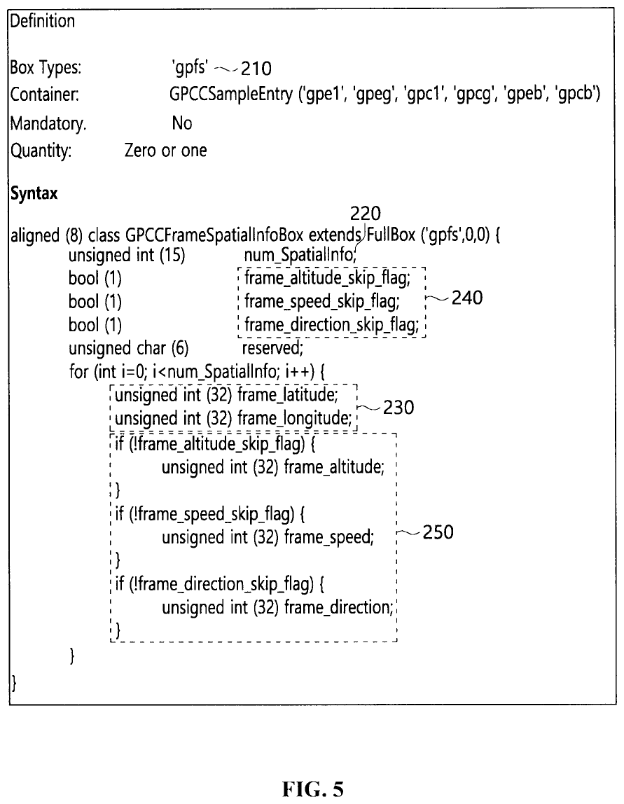

FIG. 5 is an exemplary view for explaining a frame spatial information box according to an embodiment.

A SampleEntry box of the ISOBMFF standard may include ‘gpe1’, ‘gpeg’, ‘gpc1’, ‘gpcg’, ‘gpeb’, and ‘gpcb’. Here, as illustrated in FIG. 5, a frame spatial information box (‘gpfs’) 210 is newly generated and defined in the SampleEntry box according to an embodiment, and location information of a 3D spatial data frame is stored in the frame spatial information box, whereby spatial random access may be supported.

Also, the frame spatial information box may include the number of 3D spatial data frames having location information (num_SpatialInfo) 220 and information about the latitude and longitude of each frame (frame latitude and frame longitude) 230.

Also, the frame spatial information box may further include frame altitude information, frame speed information, and frame direction information 250.

Here, each of the frame altitude information, the frame speed information, and frame direction information 250 may be omitted depending on skip flag information 240 indicating whether or not a parameter therefor is omitted.

That is, a frame altitude skip flag, a frame speed skip flag, and a frame direction skip flag respectively indicate information about whether a frame altitude parameter is omitted, information about whether a frame speed parameter is omitted, and information about whether a frame direction parameter is omitted.

Meanwhile, referring again to FIG. 3, the method for providing 3D spatial data based on spatial random access according to an embodiment may further include transmitting the 3D spatial data encapsulated for each group of frames to a user through a media transmission protocol at step S150.

Here, the media transmission protocol used for transmission has to support a spatial random access function as well as the functions of an existing media transmission protocol, such as adaptive streaming and the like.

That is, spatial random access to a 3D spatial data frame may be supported using the location information included in the frame spatial information box. A user may perform spatial random access to the 3D spatial data based on the location information, thereby being provided with desired content and consuming the same. That is, the 3D spatial data acquired through spatial random access may be consumed at step S160 through services such as autonomous driving, augmented reality, virtual reality, and the like.

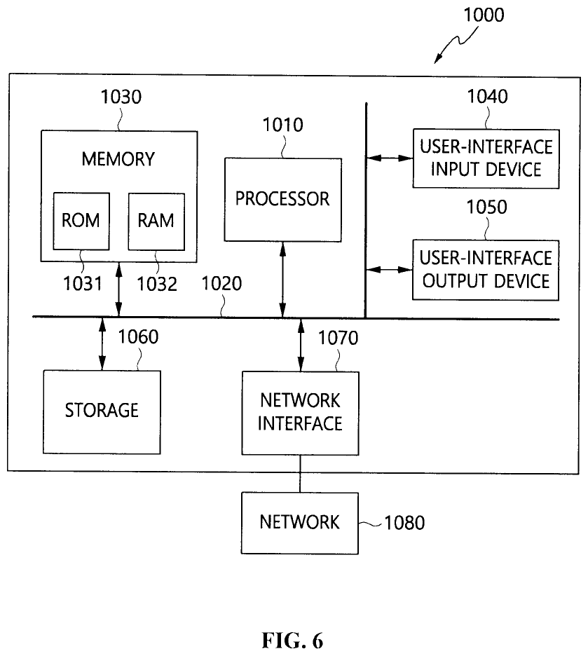

FIG. 6 is a view illustrating a computer system configuration according to an embodiment.

The apparatus for providing 3D spatial data based on spatial random access according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060.

Here, the program according to an embodiment may perform the method for providing 3D spatial data based on spatial random access, which is described above with reference to FIGS. 3 to 5.

The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, when 3D spatial data is compressed and transmitted, a system provider may provide 3D spatial data desired by a consumer, among multiple pieces of 3D spatial data, by performing spatial random access thereto based on the location thereof.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for providing three-dimensional (3D) spatial data based on spatial random access, comprising:
generating multiple groups of frames by grouping 3D spatial data based on an adjacent location in a space;
compressing the 3D spatial data for each of the groups of frames; and
encapsulating a compressed 3D spatial data bitstream for each of the groups of frames.

2. The method of claim 1, wherein each of the groups of frames includes an I frame that is a reference frame, a P frame that refers to one of adjacent I frames and P frames when being decoded, and a B frame that refers to at least two of adjacent I frames and P frames when being decoded.

3. The method of claim 1, wherein encapsulating the compressed 3D spatial data bitstream comprises generating a 3D spatial data file in an ISO base media file format (ISOBMFF), which supports spatial random access, from the compressed 3D spatial data bitstream.

4. The method of claim 1, wherein encapsulating the compressed 3D spatial data bitstream comprises generating a frame spatial information box in a SampleEntry box of an ISOBMFF standard and storing location information of 3D spatial data frames for each of the groups of frames therein.

5. The method of claim 4, wherein the location information of the 3D spatial data frame is absolute coordinates of the 3D spatial data frame or relative coordinates of a group of 3D spatial data frames.

6. The method of claim 4, wherein the frame spatial information box includes a number of 3D spatial data frames having location information (num_SpatialInfo), frame latitude information, and frame longitude information.

7. The method of claim 4, wherein:
the frame spatial information box includes frame altitude information, frame speed information, and frame direction information, and
each of the frame altitude information, the frame speed information, and the frame direction information is omitted depending on skip flag information indicating whether a parameter therefor is omitted.

8. The method of claim 1, further comprising:
transmitting the 3D spatial data encapsulated for each of the groups of frames to a user through a media transmission protocol,
wherein spatial random access to a 3D spatial data frame is supported using location information included in a frame spatial information box.

9. An apparatus for providing three-dimensional (3D) spatial data based on spatial random access, comprising:
memory in which at least one program is recorded; and
a processor for executing the program,
wherein the program generates multiple groups of frames by grouping 3D spatial data based on an adjacent location in a space, compresses the 3D spatial data for each of the groups of frames, and encapsulates a compressed 3D spatial data bitstream for each of the groups of frames.

10. The apparatus of claim 9, wherein each of the groups of frames includes an I frame that is a reference frame, a P frame that refers to one of adjacent I frames and P frames when being decoded, and a B frame that refers to at least two of adjacent I frames and P frames when being decoded.

11. The apparatus of claim 9, wherein, when encapsulating the compressed 3D spatial data bitstream, the program generates a 3D spatial data file in an ISO base media file format (ISOBMFF), which supports spatial random access, from the compressed 3D spatial data bitstream.

12. The apparatus of claim 9, wherein, when encapsulating the compressed 3D spatial data bitstream, the program generates a frame spatial information box in a SampleEntry box of an ISOBMFF standard and stores location information of 3D spatial data frames for each of the groups of frames therein.

13. The apparatus of claim 12, wherein the location information of the 3D spatial data frame is absolute coordinates of the 3D spatial data frame or relative coordinates of a group of 3D spatial data frames.

14. The apparatus of claim 12, wherein the frame spatial information box includes a number of 3D spatial data frames having location information (num_SpatialInfo), frame latitude information, and frame longitude information.

15. The apparatus of claim 12, wherein:
the frame spatial information box includes frame altitude information, frame speed information, and frame direction information, and
each of the frame altitude information, the frame speed information, and the frame direction information is omitted depending on skip flag information indicating whether a parameter therefor is omitted.

16. The apparatus of claim 9, wherein:
the program transmits the 3D spatial data encapsulated for each of the groups of frames to a user through a media transmission protocol, and
the program supports spatial random access to a 3D spatial data frame using location information included in a frame spatial information box.

17. A method for providing three-dimensional (3D) spatial data based on spatial random access, comprising:
generating multiple groups of frames by grouping 3D spatial data based on an adjacent location in a space;
compressing the 3D spatial data for each of the groups of frames;
encapsulating a compressed 3D spatial data bitstream for each of the groups of frames; and
transmitting the 3D spatial data encapsulated for each of the groups of frames to a user through a media transmission protocol,
wherein:
encapsulating the compressed 3D spatial data bitstream comprises generating a frame spatial information box in a SampleEntry box of an ISO base media file format (ISOBMFF) standard and storing location information of 3D spatial data frames for each of the groups of frames therein, and
transmitting the 3D spatial data comprises supporting spatial random access to the 3D spatial data frame using the location information included in the frame spatial information box.

18. The method of claim 17, wherein each of the groups of frames includes an I frame that is a reference frame, a P frame that refers to one of adjacent I frames and P frames when being decoded, and a B frame that refers to at least two of adjacent I frames and P frames when being decoded.

19. The method of claim 17, wherein the frame spatial information box includes a number of 3D spatial data frames having location information (num_SpatialInfo), frame latitude information, and frame longitude information.

20. The method of claim 19, wherein:
the frame spatial information box further includes frame altitude information, frame speed information, and frame direction information, and
each of the frame altitude information, the frame speed information, and the frame direction information is omitted depending on skip flag information indicating whether a parameter therefor is omitted.
